(19) United States
(12) Patent Application Publication
(10) Pub. No.: US 2025/0133426 A1
(43) Pub. Date: Apr. 24, 2025

(54) NOTIFICATION OF CARRIER FAILURE CONDITION

(71) Applicant: Lenovo (Singapore) Pte. Ltd., Singapore (SG)

(72) Inventors: Joachim Löhr, Wiesbaden (DE); Prateek Basu Mallick, Dreieich (DE)

(21) Appl. No.: 18/920,433

(22) Filed: Oct. 18, 2024

Related U.S. Application Data
(60) Provisional application No. 63/592,120, filed on Oct. 20, 2023.

(51) Int. Cl. H04W 24/04; H04L 1/1812; H04W 52/02; H04W 72/0453; H04W 72/40; H04W 76/28

(52) U.S. Cl. CPC H04W 24/04; H04L 1/1812; H04W 52/0238; H04W 72/0453; H04W 72/40; H04W 76/28

(57) ABSTRACT

Various aspects of the present disclosure relate to receiving a configuration that indicates a plurality of carriers for sidelink (SL) communication and tracking a number of consecutive discontinuous transmission (DTX) instances for each SL carrier of the plurality of carriers. Aspects of the present disclosure may relate to determining a carrier failure condition for a respective SL carrier based at least in part on a tracked number of consecutive DTX instances satisfying a threshold and transmitting a notification to a base station, the notification indicating the carrier failure condition for the respective SL carrier.

### TECHNICAL FIELD

The present disclosure relates to wireless communications, and more specifically to techniques for recovering from sidelink (SL) carrier failure.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Sidelink (SL) communication refers to peer-to-peer communication directly between UEs. Accordingly, the UEs communicate with one another without the communications being relayed via the mobile network (i.e., without the need of a base station).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

Some implementations of the method and apparatuses described herein may include means for receiving a configuration that indicates a plurality of carriers for SL communication. The method and apparatuses described herein may include means for tracking a number of consecutive discontinuous transmission (DTX) instances for each SL carrier of the plurality of carriers determining whether a SL carrier failure condition occurs for at least one SL carrier of the set of SL carrier. The method and apparatuses described herein may include means for determining a carrier failure condition for a respective SL carrier based at least in part on a tracked number of consecutive DTX instances satisfying a threshold. The method and apparatuses described herein may include means for transmitting a notification to a base station, the notification indicating the carrier failure condition for the respective SL carrier.

In some implementations of the method and apparatuses described herein may include means for transmitting a configuration that indicates a plurality of carriers for SL communication and a threshold for carrier failure. The method and apparatuses described herein may include means for receiving a notification from a UE, the notification indicating a carrier failure condition for a respective SL carrier of the plurality of carriers based on a tracked number of consecutive DTX instances satisfying the threshold. The method and apparatuses described herein may include means for scheduling an SL resource allocation based at least in part on the notification indicating the carrier failure condition for the respective SL carrier. The method and apparatuses described herein may include means for transmitting the SL resource allocation from the UE.

### BRIEF DESCRIPTION OF THE DRAWINGS

FIG. 1 illustrates an example of a wireless communication system in accordance with aspects of the present disclosure.

FIG. 2 illustrates an example of a protocol stack, in accordance with aspects of the present disclosure.

FIG. 3 illustrates an example of a radio frame during which a listen-before-talk (LBT) procedure is performed, in accordance with aspects of the present disclosure.

FIG. 4 illustrates an example of a SL protocol stack showing different protocol layers in a pair of UEs, in accordance with aspects of the present disclosure.

FIG. 5 illustrates an example of a range estimation using a medium access control (MAC) protocol data unit (PDU) for SL operation in a cell with shared spectrum channel access, in accordance with aspects of the present disclosure.

FIG. 6 illustrates an example of handling a SL carrier failure, in accordance with aspects of the present disclosure.

FIG. 7 illustrates an example of detecting SL radio link failure (RLF), in accordance with aspects of the present disclosure.

FIG. 8 illustrates an example of a user equipment (UE) 800, in accordance with aspects of the present disclosure.

FIG. 9 illustrates an example of a processor 900, in accordance with aspects of the present disclosure.

FIG. 10 illustrates an example of a network equipment (NE) 1000, in accordance with aspects of the present disclosure.

FIG. 11 illustrates a flowchart of a method performed by a UE, in accordance with aspects of the present disclosure.

FIG. 12 illustrates a flowchart of a method performed by a NE, in accordance with aspects of the present disclosure.

### DETAILED DESCRIPTION

Generally, the present disclosure describes systems, methods, and apparatuses for SL operation in a cell with shared spectrum channel access. In certain embodiments, the methods may be performed using computer-executable code embedded on a computer-readable medium. In certain embodiments, an apparatus or system may include a computer-readable medium containing computer-readable code which, when executed by a processor, causes the apparatus or system to perform at least a portion of the below described solutions.

In certain wireless communications networks, such as in NR unlicensed (NR-U) operation, channel access in both downlink (DL) and uplink (UL) relies on an LBT procedure to determine channel availability. In such embodiments, a radio node, e.g., base station unit (e.g., gNB) and/or UE, must first sense the channel to find out there are no on-going communications prior to any transmission. When a communication channel is a wide bandwidth unlicensed carrier, a clear channel assessment (CCA) procedure relies on detecting an energy level on multiple sub-bands of a communications channel. In some embodiments, no beamforming is considered for LBT in NR-U and only omni-directional LBT is used.

In 3GPP Release 16 (Rel-16), SL communication was developed in RAN mainly to support advanced vehicle-to-everything (V2X) applications. In 3GPP Release 17 (Rel-17), Proximity-based Service (ProSe) was standardized, including public safety and commercial related service. As part of Rel-17, power saving solutions (e.g., partial sensing, discontinuous reception (DRX), etc.) and inter-UE coordination have been developed in RAN1 and RAN2 to improve power consumption for battery limited terminals and reliability of SL transmissions.

As part of 3GPP Release 18 (Rel-18) for NR SL evolution, the concept of per carrier “carrier failure” is introduced. In the transmitter UE (Tx UE), if “carrier failure” is declared for a carrier, the carrier should be removed (or released). The carrier selection (or re-selection) can be triggered. For the SL use case, this carrier can be released, e.g., via PC5 Radio Resource Control (RRC) reconfiguration.

Once a UE detects (i.e., triggers) a SL carrier failure for a SL transmitter (Tx) carrier, the corresponding SL Tx carrier is removed (or released) and not considered anymore as a candidate SL Tx carrier for Tx carrier selection (e.g., for SL transmission). Therefore, a recovery procedure needs to be defined for a Tx carrier for which SL carrier failure was detected.

According to the current 3GPP specifications, the UE would not consider a removed (or released) SL carrier for future Tx carrier (re) selection (e.g., for SL transmission) which would lead to a decreased SL bandwidth (BW) being available for SL transmission and hence decreased throughput. The disclosure provides solutions for recovery of a SL carrier failure, so that a previously removed (or released) SL Tx carrier can be used again for future SL transmissions.

The present disclosure provides several solutions in several embodiments defining a recovery mechanism for cases when a SL carrier failure was detected for a SL Tx carrier due to reaching (or exceeding) a predefined number of consecutive DTX.

In a first set of solutions, a timer based recovery procedure is detailed, where the Tx UE cancels a previously triggered SL carrier failure upon the expiry of a newly introduced timer. Accordingly, a new timer is introduced which controls the time when a previously removed (or released) SL carrier can be considered again by the UE for Carrier selection (e.g., for SL transmission). The new timer is used for the recovery of a SL Tx carrier for which SL carrier failure was detected. The timer is started upon the trigger of a SL carrier failure. Upon expiry of the timer, a triggered SL carrier failure is cancelled.

In another set of solutions, a UE disables packet data convergence protocol (PDCP) duplication for a SL radio bearer (SLRB) for cases where the secondary leg(s)/carrier(s) being associated with the PDCP entity of the SLRB have been removed (or released) due to a detected SL carrier failure. According to one implementation, the Tx UE disables PDCP duplication for the case where there is no secondary SL carrier available for a SLRB due to SL carrier failure(s) having occurred on the secondary carrier(s).

Aspects of the present disclosure are described in the context of a wireless communications system.

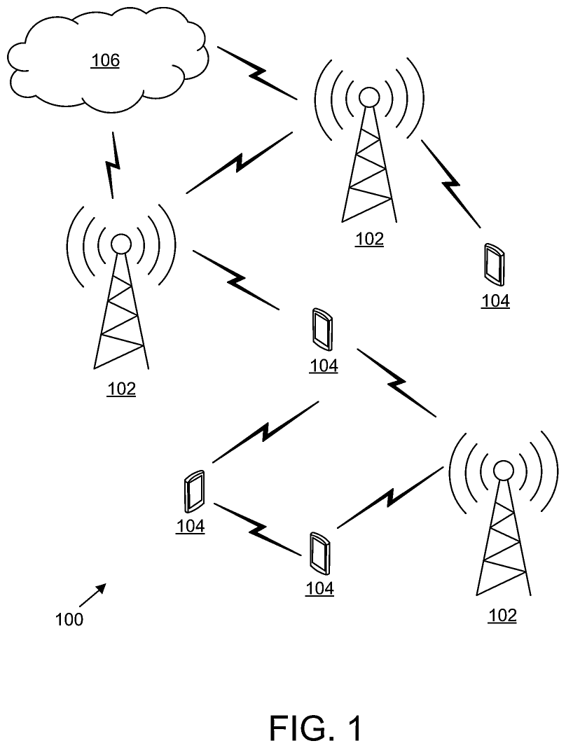

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an long-term evolution (LTE) network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink (SL). For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHZ), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

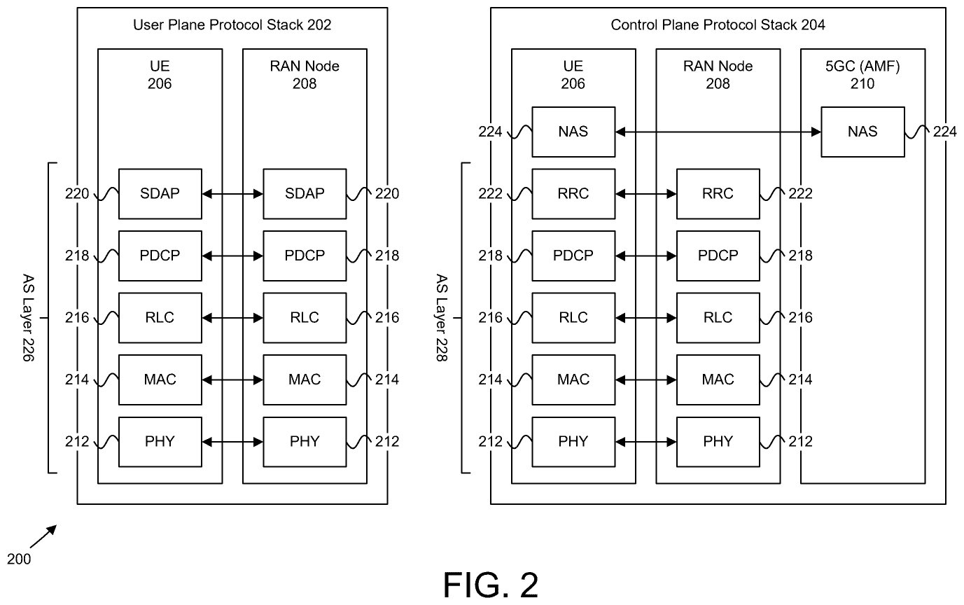

FIG. 2 illustrates an example of a protocol stack 200, in accordance with aspects of the present disclosure. While FIG. 2 shows a UE 206, a RAN node 208, and a 5GC 210 (e.g., comprising at least an AMF), these are representative of a set of UEs 104 interacting with an NE 102 (e.g., base station) and a CN 106. As depicted, the protocol stack 200 comprises a User Plane protocol stack 202 and a Control Plane protocol stack 204. The User Plane protocol stack 202 includes a PHY layer 212, a MAC sublayer 214, a Radio Link Control (RLC) sublayer 216, a Packet Data Convergence Protocol (PDCP) sublayer 218, and a Service Data Adaptation Protocol (SDAP) layer 220. The Control Plane protocol stack 204 includes a PHY layer 212, a MAC sublayer 214, a RLC sublayer 216, and a PDCP sublayer 218. The Control Plane protocol stack 204 also includes a Radio Resource Control (RRC) layer 222 and a Non-Access Stratum (NAS) layer 224.

The AS layer 226 (also referred to as “AS protocol stack”) for the User Plane protocol stack 202 consists of at least SDAP, PDCP, RLC and MAC sublayers, and the physical layer. The AS layer 228 for the Control Plane protocol stack 204 consists of at least RRC, PDCP, RLC and MAC sublayers, and the physical layer. The Layer-1 (L1) includes the PHY layer 212. The Layer-2 (L2) is split into the SDAP sublayer 220, PDCP sublayer 218, RLC sublayer 216, and MAC sublayer 214. The Layer-3 (L3) includes the RRC layer 222 and the NAS layer 224 for the control plane and includes, e.g., an internet protocol (IP) layer and/or PDU Layer (not depicted) for the user plane. L1 and L2 are referred to as “lower layers,” while L3 and above (e.g., transport layer, application layer) are referred to as “higher layers” or “upper layers.”

The PHY layer 212 offers transport channels to the MAC sublayer 214. The PHY layer 212 may perform a beam failure detection procedure using energy detection thresholds, as described herein. In certain embodiments, the PHY layer 212 may send an indication of beam failure to a MAC entity at the MAC sublayer 214. The MAC sublayer 214 offers logical channels (LCHs) to the RLC sublayer 216. The RLC sublayer 216 offers RLC channels to the PDCP sublayer 218.

The PDCP sublayer 218 offers radio bearers to the SDAP sublayer 220 and/or RRC layer 222. In certain embodiments, the PDCP sublayer 218 provides duplication of data packets (referred to as “PDCP duplication”) across different transmission paths to improve resilience against packet loss. When PDCP duplication is enabled, the same data packet is duplicated and transmitted over two or more independent transmission paths (e.g., via different radio bearers or different cells). For example, in dual connectivity (i.e., where the UE 206 connected to two different base stations), the duplicated PDCP PDUs may be sent via both paths. At the receiver side, the PDCP sublayer 218 discards any duplicates that arrive after the first successfully received packet. Note that PDCP duplication is transparent to the upper layers, such that applications are unaware that duplication is happening.

The SDAP sublayer 220 offers QoS flows to the core network (e.g., 5GC). The RRC layer 222 provides for the addition, modification, and release of carrier aggregation (CA) and/or dual connectivity. The RRC layer 222 also manages the establishment, configuration, maintenance, and release of Signaling Radio Bearers (SRBs) and Data Radio Bearers (DRBs).

The NAS layer 224 is between the UE 206 and an AMF in the 5GC 210. NAS messages are passed transparently through the RAN. The NAS layer 224 is used to manage the establishment of communication sessions and for maintaining continuous communications with the UE 206 as it moves between different cells of the RAN. In contrast, the AS layers 226 and 228 are between the UE 206 and the RAN (i.e., RAN node 208) and carry information over the wireless portion of the network. While not depicted in FIG. 2, the IP layer exists above the NAS layer 224, a transport layer exists above the IP layer, and an application layer exists above the transport layer.

The MAC sublayer 214 is the lowest sublayer in the L2 architecture of the NR protocol stack. Its connection to the PHY layer 212 below is through transport channels, and the connection to the RLC sublayer 216 above is through LCHs. The MAC sublayer 214 therefore performs multiplexing and demultiplexing between LCHs and transport channels: the MAC sublayer 214 in the transmitting side constructs MAC PDUs (also known as Transport Blocks (TBs)) from MAC Service Data Units (SDUs) received through LCHs, and the MAC sublayer 214 in the receiving side recovers MAC SDUs from MAC PDUs received through transport channels.

The MAC sublayer 214 provides a data transfer service for the RLC sublayer 216 through LCHs, which are either control LCHs which carry control data (e.g., RRC signaling) or traffic LCHs which carry user plane data. On the other hand, the data from the MAC sublayer 214 is exchanged with the PHY layer 212 through transport channels, which are classified as UL or DL. Data is multiplexed into transport channels depending on how it is transmitted over the air.

The PHY layer 212 is responsible for the actual transmission of data and control information via the air interface, i.e., the PHY layer 212 carries all information from the MAC transport channels over the air interface on the transmission side. Some of the important functions performed by the PHY layer 212 include coding and modulation, link adaptation (e.g., Adaptive Modulation and Coding (AMC)), power control, cell search and random access (for initial synchronization and handover purposes) and other measurements (inside the 3GPP system (i.e., NR and/or LTE system) and between systems) for the RRC layer 222. The PHY layer 212 performs transmissions based on transmission parameters, such as the modulation scheme, the coding rate (i.e., the modulation and coding scheme (MCS)), the number of Physical Resource Blocks (PRBs), etc.

In some embodiments, the protocol stack 200 may be an NR protocol stack used in a 5G NR system. Note that an LTE protocol stack comprises similar structure to the protocol stack 200, with the differences that the LTE protocol stack lacks the SDAP sublayer 220 in the AS layer 226, that an EPC replaces the 5GC 510, and that the NAS layer 224 is between the UE 206 and an MME in the EPC. Also note that the present disclosure distinguishes between a protocol layer (such as the aforementioned PHY layer 212, MAC sublayer 214, RLC sublayer 216, PDCP sublayer 218, SDAP sublayer 220, RRC layer 222 and NAS layer 224) and a transmission layer in Multiple-Input Multiple-Output (MIMO) communication (also referred to as a “MIMO layer” or a “data stream”).

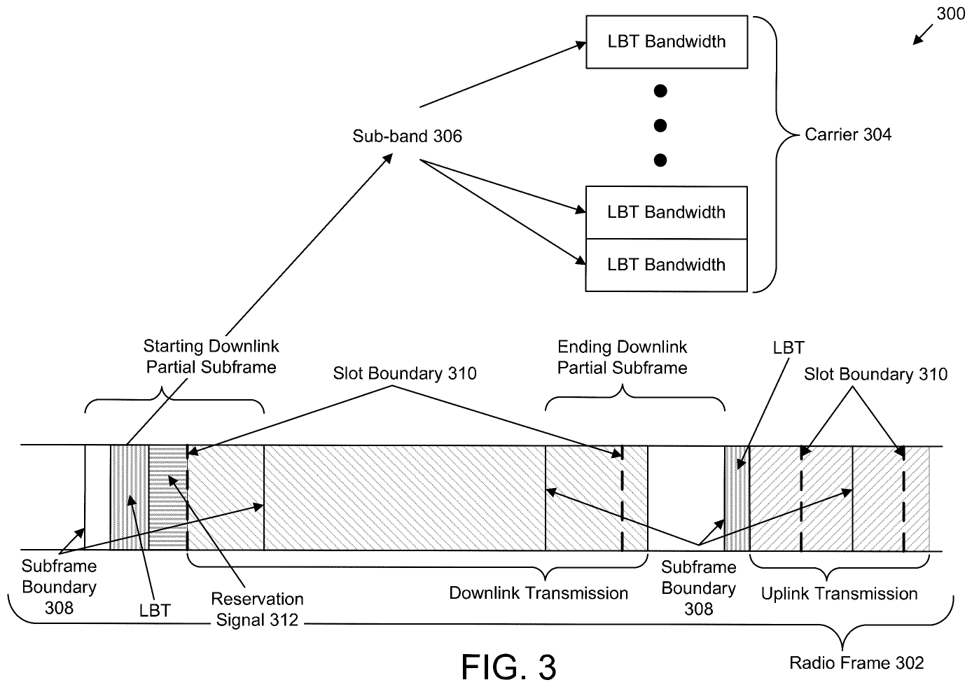

FIG. 3 depicts an LBT procedure 300 for a radio frame 302 for communication on unlicensed spectrum, according to embodiments of the disclosure. When a communication channel is a wide bandwidth unlicensed carrier 304 (e.g., several hundred MHz), the CCA/LBT procedure relies on detecting the energy level on multiple sub-bands 306 of the communications channel as shown in FIG. 3. The LBT parameters (such as type/duration, clear channel assessment parameters, etc.) may be configured in the UE 206 by the RAN node 208. In one embodiment, the LBT procedure is performed at the PHY layer 212.

FIG. 3 also depicts frame structure of the radio frame 302 for communication between the UE 206 and RAN node 208 on unlicensed spectrum. The radio frame 302 may be divided into subframes (indicated by subframe boundaries 308) and may be further divided into slots (indicated by slot boundaries 310). The radio frame 302 uses a flexible arrangements where UL and DL operations are on the same frequency channel but are separated in time. However, the subframes are not configured as a DL subframe or an UL subframe and a particular subframe may be used by either the UE 206 or RAN node 208. As discussed previously, LBT is performed prior to a transmission. Where LBT does not coincide with a slot boundary 310, a reservation signal 312 may be transmitted to reserve (i.e., occupy) the channel until the slot boundary is reached and data transmission begins.

With respect to LBT failure handling, the MAC sublayer 214 relies on reception of a notification of LBT failure from the PHY layer 212 to detect/declare consistent UL LBT failure. The UE 206 switches to another bandwidth part (BWP) and initiates a random-access procedure (i.e., RACH procedure) upon declaration of consistent UL LBT failure on a PCell or a PSCell, if there is another BWP with configured Random Access Channel (RACH) resources.

The UE 206 performs RLF recovery if the consistent UL LBT failure was detected on the PCell, and UL LBT failure was detected on ‘N’ possible BWP. When consistent UL LBT failures are detected on the PSCell, the UE 206 informs the RAN, via the secondary cell group (SCG) failure information procedure, after detecting a consistent UL LBT failure on ‘N’ BWPs, where ‘N’ is the number of configured BWPs with configured Physical Random Access Channel (PRACH) resources. If ‘N’ is larger than one, it is up to the UE implementation which BWP the UE selects.

When consistent UL LBT failures are detected on a SCell, the UE 206 transmits a new MAC control element (MAC-CE) to report the consistent UL LBT failure to the node to which the SCell belongs. In certain embodiments, the MAC-CE can be used to report failure on the PCell.

In other words, in the case of consistent LBT failure, the UE 206 is allowed to autonomously switch the UL BWP. The motivation is that other UL BWP(s) of the NR-U cell may not be subject to large number of LBT failures, i.e., different LBT sub-bands 306 are used for different UL BWP(s).

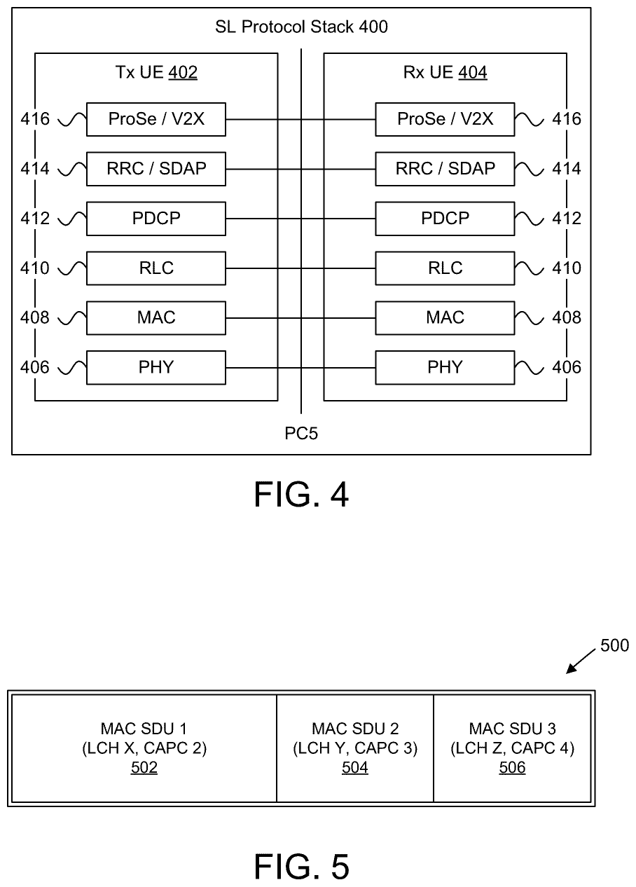

FIG. 4 illustrates a SL protocol stack 400, in accordance with aspects of the present disclosure. While FIG. 4 shows a SL transmitter UE (Tx UE) 402 and a SL receiver UE (Rx UE) 404, these are representative of a set of UEs using SL communication over a PC5 interface; other embodiments may involve different SL UEs. In various embodiments, each of the Tx UE 402 and the Rx UE 404 may be an embodiment of the UE 104 and/or the UE 206.

As depicted, the SL protocol stack 400 (i.e., PC5 protocol stack) includes a PHY layer 406, a MAC sublayer 408, a RLC sublayer 410, a PDCP sublayer 412, a SDAP sublayer (e.g., for the user plane), and an RRC sublayer (e.g., for the control plane). In FIG. 4, the SDAP sublayer and RRC sublayer are depicted as combined entity “RRC/SDAP layers” 414. There may be additional layers above the RRC/SDAP layers 414, such as a Proximity Services (ProSe) and/or V2X application layer 416.

The AS layer (also referred to as “AS protocol stack”) for the control plane in the PC5 interface consists of at least the RRC sublayer, the PDCP sublayer 412, the RLC sublayer 410, the MAC sublayer 408, and the PHY layer 406. The AS layer (also referred to as “AS protocol stack”) for the user plane in the PC5 interface consists of at least the SDAP sublayer, the PDCP sublayer 412, the RLC sublayer 410, the MAC sublayer 408, and the PHY layer 406.

Similar to the protocol stack 200, the L1 refers to the PHY layer 406. The L2 is split into the SDAP sublayer, the PDCP sublayer 412, the RLC sublayer 410, and the MAC sublayer 408. The L3 includes the RRC sublayer for the control plane and includes, e.g., an IP layer or PDU Layer (not depicted) for the user plane. L1 and L2 are generally referred to as “lower layers,” while L3 and above (e.g., transport layer, V2X layer, application layer) are referred to as “higher layers” or “upper layers.” The PHY layer 406, the MAC sublayer 408, the RLC sublayer 410, and the PDCP sublayer 412 perform similar functions as the PHY layer 212, the MAC sublayer 214, the RLC sublayer 216, and the PDCP sublayer 218, described above with reference to FIG. 2.

In various embodiments, the SL communication relates to one or more services requiring SL connectivity, such as V2X services and ProSe services. The Tx UE 402 may establish one or more SL connections with nearby Rx UE 404. For example, a V2X application running on the Tx UE 402 may generate data relating to a V2X service and use a SL connection to transmit the V2X data to one or more nearby Rx UE 404.

Note that the Tx UE 402 and/or Rx UE 404 may be provided with different SL communication resources according to different allocation modes. Allocation Mode-1 corresponds to a NR-based network-scheduled SL communication mode, wherein the in-coverage gNB indicates resources for use in SL operation, including resources of one or more resource pools. Allocation Mode-2 corresponds to a NR-based UE-scheduled SL communication mode (i.e., UE-autonomous selection), where the Tx UE 402 and/or Rx UE 404 selects a resource pools and resources therein from a set of candidate pools. Allocation Mode-3 corresponds to an LTE-based network-scheduled SL communication mode. Allocation Mode-4 corresponds to an LTE-based UE-scheduled SL communication mode (i.e., UE-autonomous selection).

As used herein, a “resource pool” refers to a set of resources assigned for SL operation. A resource pool consists of a set of resource blocks (i.e., Physical Resource Blocks (PRBs)) over one or more time units (e.g., Orthogonal Frequency Division Multiplexing (OFDM) symbols, subframes, slots, subslots, etc.). In some embodiments, the set of resource blocks comprises contiguous PRBs in the frequency domain. A PRB, as used herein, consists of twelve consecutive subcarriers in the frequency domain. In certain embodiments, a UE may be configured with separate transmission resource pools (Tx RPs) and reception resource pools (Rx RPs), where the Tx RP of one UE is associated with an Rx RP of another UE to enable SL communication.

In NR-U, channel access in both DL and UL relies on the LBT procedure. The gNB and/or UE must first sense the channel to find out there are no ongoing communications prior to any transmission. When a communication channel is a wide bandwidth unlicensed carrier, the LBT/CCA procedure relies on detecting the energy level on multiple sub-bands of the communications channel as shown in FIG. 3. Note that no beamforming is considered for LBT in NR-U in Release 16 (Rel-16) and only omni-directional LBT is assumed.

In LBT, transmitters are expected to “sense” the medium, based on a Clear Channel Assessment (CCA) protocol, and detect transmissions from other nodes prior to transmitting. The simplest CCA method is energy detection, e.g., to measure the received energy level of signals transmitted from other devices and determine whether a channel is idle or busy.

Regarding SL operation in unlicensed spectrum, in Rel-16, SL communication was developed in RAN mainly to support advanced V2X applications. In Rel-17, ProSe including public safety and commercial related service were standardized. As part of Rel-17, power saving solutions (e.g., partial sensing, DRX) and inter-UE coordination were developed to improve power consumption for battery limited terminals and reliability of SL transmissions.

Although NR SL was initially developed for V2X applications, there is growing interest in the industry to expand the applicability of NR SL to commercial use cases. For commercial SL applications, two key requirements have been identified: 1) increased SL data rate, and 2) support of new carrier frequencies for SL.

Increased SL data rate is motivated by applications such as sensor information (video) sharing between vehicles with high degree of driving automation. Commercial use cases could require data rates in excess of what is possible in Rel-17. Increased data rate can be achieved with the support of sidelink carrier aggregation (SL CA) and sidelink over unlicensed spectrum.

In Rel-18, channel access mechanisms from NR-U may be reused for sidelink unlicensed (“SL-U”) operation. For example, the existing NR SL and NR-U channel structure may be reused in SL-U as the baseline. In certain embodiments, for SL-U operation, the gNB does not perform Type 1 channel access to initiate and share a channel occupancy, neither Type 2 channel access to share an initiated channel occupancy, nor semi-static channel access procedures to access an unlicensed channel.

Furthermore, by enhancing the FR2 SL operation, increased data rate can be more efficiently supported on FR2. While the support of new carrier frequencies and larger bandwidths would also allow improvement to data rate, the main benefit would come from making SL more applicable for a wider range of applications. More specifically, with the support of unlicensed spectrum and the enhancement in FR2, SL will be in a better position to be implemented in commercial devices since utilization of the Intelligent Transportation Systems (ITS) band is limited to ITS safety related applications.

Various systems may support SL communication on unlicensed spectrum for both mode 1 and mode 2 where Uu operation for mode 1 is limited to licensed spectrum only. In certain embodiments, the channel access mechanisms from NR-U (discussed above with reference to FIG. 3) are reused for SL-U operation and the existing NR SL and NR-U channel structure are also reused, as the baseline, for SL-U operation. In other words, the SL devices perform LBT/CCA prior to occupying a channel on unlicensed spectrum.

In NR-U when the UE 206 detects consistent UL LBT failures, it takes actions as specified in 3GPP technical specification (TS) 38.321 and described above. The detection is per Bandwidth Part (BWP) and based on all UL transmissions within this BWP. For cases when SL is operated on a cell configured with, the corresponding UE actions upon detection of consistent LBT failures for SL transmissions on a resource block set and/or resource pool (RP) need to be defined.

For SL unlicensed, once a consistent LBT failure has been declared, among others it results into a situation where a SL receiver device (i.e., the Rx UE 404) may not be able to transmit hybrid automatic repeat request (HARQ) feedback about a successful or failed reception to a corresponding SL transmitter device (i.e., the Tx UE 402). In absence of multiple of such HARQ feedback(s), i.e., when sl-MaxNumConsecutiveDTX is reached, the Tx UE 402 may deduce that the link between it and the Rx UE 404 has met RLF for the NR SL communication transmission and the corresponding PC5-RRC connection is released.

As used herein, HARQ-ACK may represent collectively the Positive Acknowledge (ACK) and the Negative Acknowledge (NACK) and Discontinuous Transmission (DTX). ACK means that a transport block (TB) is correctly received while NACK (or NAK) means a TB is erroneously received and DTX means that no TB was detected. HARQ operates multiple processes (also referred to as “HARQ processes”) in parallel, allowing the transmission of new data while waiting for ACK/NACK feedback from previous transmissions. For example, in 5G NR DL and UL, there can be up to 16 HARQ processes simultaneously active to maintain high data throughput and to minimize interruption and delays. Each HARQ process (e.g., for UL, DL, or SL) may be assigned a unique identifier (ID) to allow the UE and RAN to differentiate between the different active HARQ processes.

FIG. 5 is a schematic block diagram illustrating one embodiment of a MAC PDU 500, in accordance with aspects of the present disclosure. The MAC PDU 500 includes a first MAC SDU (denoted “MAC SDU 1”) 502, a second MAC SDU (denoted “MAC SDU 2”) 504, and a third MAC SDU (denoted “MAC SDU 3”) 506. Here, the first MAC SDU 502 is formed from data associated with a first LCH (denoted “LCH X”), and a certain channel access priority class (CAPC) value (here, “CAPC 2”), the second MAC SDU 504 is formed from data associated with a second LCH (denoted “LCH Y”), and a certain CAPC value (here, “CAPC 3”), and the third MAC SDU 506 is formed from data associated with a third LCH (denoted “LCH Z”), and a certain CAPC value (here, “CAPC 4”). In various embodiments, the MAC PDU 500 forms a TB to be transmitted via SL communication.

In certain embodiments, NR-U LBT procedures for channel access may be summarized as follows: 1) both gNB-initiated and UE-initiated Channel Occupancy Times (COTs) use category 4 (Cat4) LBT operation where the start of a new transmission burst always performs an LBT procedure with exponential backoff-only with the exception that if the demodulation reference signal (DRS) is to be at most one ms in duration and is not multiplexed with unicast Physical Downlink Shared Channel (PDSCH); and/or 2) UL transmission within a gNB-initiated COT or a subsequent DL transmission within a UE or gNB-initiated COT transmits immediately without sensing only if the gap from the end of the previous transmission is not more than 16 μs; otherwise, category 2 (Cat2) LBT operation must be used and the gap cannot exceed 25 μs. An LBT procedure is said to be successful if the measured energy is lower than a threshold. In certain embodiments, for a Cat2 LBT in a 16 us gap, energy measurement is done for a total of at least 5 us with at least 4 us of sensing falling within the 9 us slot immediately before the transmission.

In some embodiments, the UE and/or gNB operating on unlicensed carriers is to perform an LBT operation, and within Cat4 LBT, several CAPCs are defined to have differentiated channel access parameters as shown in Table 1 (for the DL case) and Table 2 (for the UL case).

TABLE 1
CAPC for DL

| CAPC | | | | | allowed |
|---|---|---|---|---|---|
| (p) | mₚ | CWₘᵢₙₚ | CWₘₐₓₚ | T_{mcotp} | CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, |
| | | | | 10 ms | 255, 511, 1023} |

TABLE 2
CAPC for UL

| CAPC | | | | | allowed |
|---|---|---|---|---|---|
| (p) | mₚ | CWₘᵢₙₚ | CWₘₐₓₚ | T_{ulm cot, p} | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 or | {15, 31, 63, 127, |
| | | | | 10 ms | 255, 511, 1023} |
| 4 | 7 | 15 | 1023 | 6 or | {15, 31, 63, 127, |
| | | | | 10 ms | 255, 511, 1023} |

Note that for Table 2, for p=3,4, T_{ulm cot,p}=10 ms if the higher layer parameters absenceOfAnyOtherTechnology-r14 or absenceOfAnyOtherTechnology-r16 is provided, otherwise, T_{ulm cot,p}=6 ms. When T_{ulm cot,p}=6 ms it may be increased to 8 ms by inserting one or more gaps. The minimum duration of a gap shall be 100 μs. The maximum duration before including any such gap shall be 6 ms.

In various embodiments, for dynamically scheduled UL resources (e.g., UL DCI), a gNB indicates a CAPC to be used by a UE for a corresponding UL transmission. For an UL configured grant, a network cannot signal the CAPC index for every occasion, and thus the UE itself has to select which CAPC is used for each occasion. In certain embodiments, for data radio bearers (DRBs), a UE selects a highest CAPC index/value (e.g., corresponding to the lowest priority level) of LCHs multiplexed in a TB. According to this schema, in the FIG. 5, the UE will select the CAPC 4 from Table 2 (e.g., the lowest priority).

In certain embodiments, a very small amount of data belongs to a highest CAPC index, but a UE still has to apply the highest CAPC index for high-priority data, which leads to some delay for the transmission. Therefore, for UL CG, if SRB (e.g., downlink control channel (DCCH)) SDU is included in MAC PDU, a UE selects the CAPC index of the SRB (e.g., DCCH). Otherwise, the UE selects the highest CAPC index (e.g., lowest priority) of LCHs multiplexed in MAC PDU. As used herein a “configured grant” (i.e., CG) refers to a semi-static allocation of resources, i.e., a semi-persistently scheduled grant. Accordingly, the gNB can use a CG to schedule Physical Uplink Shared Channel (PUSCH) resources without having to transmit Downlink Control Information (DCI) to schedule every UL transmission.

In some embodiments, a CAPC of radio bearers and MAC-CEs are either fixed or configurable as being: 1) fixed to a lowest priority for a padding buffer status report (BSR) and recommended bit rate MAC-CEs; 2) fixed to a highest priority for SRB0, SRB1, SRB3, and other MAC-CEs; and/or 3) configured by the gNB for SRB2 and DRB.

In various embodiments, if choosing a CAPC of a DRB, a gNB takes into account fifth generation (5G) quality of service (QOS) IDs (5QIs) of all the QoS flows multiplexed in that DRB while considering fairness between different traffic types and transmissions. Table 3 shows which CAPC should be used for which standardized 5QIs (e.g., which CAPC to use for a given QoS flow). It should be noted that a QoS flow corresponding to a non-standardized 5QI (e.g., operator specific 5QI) should use the CAPC of the standardized 5QI which best matches the QoS characteristics of the non-standardized 5QI. In Table 3, it should be noted that a lower CAPC value may mean a higher priority.

TABLE 3
Mapping between CAPC and 5QI

| CAPC | 5QI |
|---|---|
| 1 | 1, 3, 5, 65, 66, 67, 69, 70, 79, 80, 82, 83, 84, 85 |
| 2 | 2, 7, 71 |
| 3 | 4, 6, 8, 9, 72, 73, 74, 76 |
| 4 | — |

In SL-U operation, the SL CAPC mapping table may be as shown in Table 4. Table 4 shows which CAPC should be used for which standardized PC5 QOS IDs (PQIs). It should be noted that a QoS flow corresponding to a non-standardized PQI (e.g., operator specific PQI) should use the CAPC of the standardized PQI which best matches the QoS characteristics of the non-standardized PQI. In Table 4, it should be noted that a lower CAPC value may mean a higher priority.

TABLE 4
Mapping between CAPC and PQI

| CAPC | PQI |
|---|---|
| 1 | 21, 22, 23, 24, 26, 55, 56, 57, 58, 60, 90, 91, 92, 93 |
| 2 | 25 |
| 3 | 59, 61 |
| 4 | — |

As in NR-U, the lowest priority CAPC of the LCH(s) with MAC SDU multiplexed in the TB is used regardless of whether the TB also contains SL MAC-CEs in addition to MAC SDUs. For a UE in the IDLE or INACTIVE or Out-of-Coverage (OOC) state, if a QoS flow cannot be mapped to a non-default SLRB: 1) if the per-bearer CAPC is configured in SIB (or pre-configured in the UE), the UE use the configured CAPC; 2) else, the UE selects the CAPC of the standardized PQI which best matches the QoS characteristics of the non-standardized QoS flow based on one or more QoS characteristics. For a standardized QoS flow, CAPC is directly derived from the SL CAPC table.

Regarding SL LCH prioritization (LCP), the UE can either select 1) to do a changed-LCP, in order to satisfy the COT requirement, and to do the type-2 LBT (How to do the LCP can be decided after RAN1 agreement) or 2) to do a legacy-LCP, e.g., using type-1, type-2 LBT.

In certain embodiments, if multiple Physical Sidelink Feedback Channel (PSFCH) occasions per Physical Sidelink Control Channel (PSCCH) and/or Physical Sidelink Shared Channel (PSSCH) is supported in RAN1, if HARQ ACK or NACK (collectively referred to as “HARQ-ACK”) is successfully transmitted in one PSFCH occasion, the Rx UE starts the sl-drx-HARQ-RTT-Timer for the corresponding SL HARQ process in the first slot after the end of the corresponding PSFCH transmission carrying the SL HARQ feedback. If multiple PSFCH occasion per PSCCH/PSSCH is supported in RAN1, if LBT failure happens in all PSFCH occasions, Rx UE starts the sl-drx-HARQ-RTT-Timer for the corresponding SL HARQ process in the first slot after the end of the last PSFCH occasion for the SL HARQ feedback.

In certain embodiments, the UE triggers a resource selection (or re-selection) when PSSCH transmission was not performed due to an LBT failure indication from L1.

In certain embodiments, if performing Cat4 LBT (e.g., Type 1 LBT) for the transmission of an UL TB and if the CAPC is not indicated in DCI, the UE selects the CAPC as follows: 1) if only MAC-CEs are included in the TB, the highest priority CAPC of those MAC-CEs is used; 2) if common control channel (CCCH) SDUs are included in the TB, the highest priority CAPC is used; 3) if dedicated control channel (DCCH) SDUs are included in the TB, the highest priority CAPC of the DCCHs is used; and/or 4) the lowest priority CAPC of the LCHs with MAC SDU multiplexed in the TB is used otherwise.

According to the behavior specified for NR-U for UL transmission where the CAPC is not indicated in the DCI, e.g., CG PUSCH transmissions, UE selects the lowest priority CAPC of the LCHs with MAC SDU multiplexed in the TB for cases when the TB does not contain a MAC-CE or SRB. In certain embodiments, the L1 handles LBT impact to/from other UEs' reserved resources in SL candidate resource selection (inter-UE case).

Regarding reserved resources and Channel Occupancy Time (COT), in certain embodiments, if UE observes buffer status change after LBT initiation (i.e., before MAC PDU generation), which leads to a higher CAPC priority than the value used for type-1 LBT, it is left to UE implementation how to handle this case (like NR-U).

As mentioned above, once a UE detects (i.e., triggers) a SL carrier failure for a SL Tx carrier, the corresponding SL Tx carrier is removed (or released) and not considered anymore as a candidate SL Tx carrier for Tx carrier selection (e.g., for SL transmission). Accordingly, there is a need to define a recovery procedure for a Tx carrier for which SL carrier failure was detected. The present disclosure provides several solutions in several embodiments defining a recovery mechanism for cases when a SL carrier failure was detected for a SL Tx carrier due to reaching (or exceeding) a predefined number of consecutive DTX.

Regarding Tx carrier selection (and/or re-selection) for NR SL operation, the MAC entity considers a Channel Busy Ratio (CBR) of a carrier to be one measured by lower layers (e.g., according to 3GPP TS 38.214) if CBR measurement results are available, or the corresponding parameter sl-defaultTxConfigIndex configured by upper layers if CBR measurement results are not available. CBR is a congestion metric and is defined as ratio between the time the channel is sensed as busy and the total observation time (e.g., 100 ms).

If the Tx carrier (re-)selection is triggered for a SL process (e.g., according to 3GPP TS 38.321, clause 5.22.1.1), if there is no selected SL grant on any carrier allowed for the SL LCH where data is available as indicated by upper layers, then for each carrier configured by upper layers associated with the concerned SL LCH, and if the CBR of the carrier is below the parameter sl-threshCBR-FreqReselection associated with the priority of the SL LCH, then the MAC entity considers the carrier as a candidate carrier for Tx carrier (re-) selection for the concerned SL LCH when the carrier satisfies all the following conditions.

If the parameter sl-HARQ-FeedbackEnabled is set to enabled for the SL LCH, then the carrier includes (at least) one pool of resources configured with PSFCH resources among the pools of resources except the pool(s) in sl-BWP-DiscPoolConfig or sl-BWP-DiscPoolConfigCommon (if configured). Otherwise, the carrier includes any pool of resources among the pools of resources except the pool(s) in sl-BWP-DiscPoolConfig or sl-BWP-DiscPoolConfigCommon (if configured).

However, if the Tx carrier (re-) selection is triggered for a SL process (e.g., SL HARQ process) and if there is at least one selected SL grant on any carrier allowed for the SL LCH where data is available as indicated by upper layers, then if the CBR of the carrier is below the parameter sl-threshCBR-FreqKeeping associated with priority of the SL LCH, for each SL LCH, if any, where data is available and that are allowed on the carrier for which Tx carrier (re-) selection is triggered (e.g., according to 3GPP TS 38.321, clause 5.22.1.1), then the MAC entity selects the carrier and the associated pool of resources.

Else, if the CBR of the carrier is below the parameter sl-threshCBR-FreqReselection associated with the priority of the SL LCH, them the MAC entity considers the carrier as a candidate carrier for Tx carrier (re-) selection, for each carrier configured by upper layers on which the SL LCH is allowed when the carrier satisfies all the following conditions: if sl-HARQ-FeedbackEnabled is set to enabled for the SL LCH, the carrier includes at least one pool of resources configured with PSFCH resources among the pools of resources except the pool(s) in sl-BWP-DiscPoolConfig or sl-BWP-DiscPoolConfigCommon (if configured); else the carrier includes any pool of resources among the pools of resources except the pool(s) in sl-BWP-DiscPoolConfig or sl-BWP-DiscPoolConfigCommon (if configured).

In various embodiments, if one or more carriers are considered as the candidate carriers for Tx carrier (re-) selection, and if Tx carrier (re-) selection is triggered, for each SL LCH allowed on the carrier where data is available, then the MAC entity selects one or more carrier(s) and associated pool(s) of resources among the candidate carriers with increasing order of CBR from the lowest CBR when the associated pool(s) satisfy all the following conditions: if the parameter sl-HARQ-FeedbackEnabled is set to enabled for the SL LCH, then the associated pool(s) is pool(s) of resources configured with PSFCH resources among the pools of resources except the pool(s) in sl-BWP-DiscPoolConfig or sl-BWP-DiscPoolConfigCommon (if configured); else, the associated pool(s) is any pool of resources among the pools of resources except the pool(s) in sl-BWP-DiscPoolConfig or sl-BWP-DiscPoolConfigCommon (if configured).

In case of NR SL on multiple carrier frequencies, the UE only considers SL LCHs which meet the following conditions and only considers one SL LCH among the SL LCHs corresponding to same PDCP entity, if duplication is activated (e.g., as specified in TS 38.323). The conditions include:

The SL LCH is allowed on the carrier where the Sidelink Control Information (SCI) is transmitted for NR SL, if the carrier is configured by upper layers (e.g., according to 3GPP TS 38.331 and 3GPP TS 23.287).

The SL LCH has a priority whose associated parameter sl-threshCBR-FreqReselection is no lower than the CBR of the carrier when the carrier is (re-) selected (e.g., in accordance with 3GPP TS 38.321, clause 5.22.1.11).

In various embodiments, the MAC entity selects a Destination associated to one of unicast, groupcast and broadcast, that is in the SL Active time for the SL transmission occasion if SL DRX is applied for the destination, and having at least one of the MAC-CE and the LCH with the highest priority, among the LCHs that satisfy all the following conditions and MAC-CE(s), if any, for the SL grant associated to the SCI: A) SL data is available for transmission; and B) the SL token bucket parameter SBj>0, in case there is any LCH having SBj>0; and C) the information element (IE) sl-configuredGrantType1Allowed, if configured, is set to true in case the SL grant is a Configured Grant Type 1; and D) the IE sl-AllowedCG-List, if configured, includes the configured grant index associated to the SL grant; and E) the parameter sl-HARQ-FeedbackEnabled is set to disabled, if PSFCH is not configured for the SL grant associated to the SCI.

If multiple Destinations have the LCHs satisfying all conditions above with the same highest priority or if multiple Destinations have either the MAC-CE and/or the LCHs satisfying all conditions above with the same priority as the MAC-CE, which Destination is selected among them is up to UE implementation.

In various embodiments, the MAC entity selects the LCHs satisfying all the following conditions among the LCHs belonging to the selected Destination: A) SL data is available for transmission; and B) the IE sl-configuredGrantTypelAllowed, if configured, is set to true in case the SL grant is a Configured Grant Type 1; and C) the IE sl-AllowedCG-List, if configured, includes the configured grant index associated to the SL grant; and D) the parameter sl-HARQ-FeedbackEnabled is set to the value that satisfies the following conditions:

If PSFCH is configured for the SL grant associated to the SCI and the UE is capable of PSFCH reception, then 1) the parameter sl-HARQ-FeedbackEnabled is set to enabled, if sl-HARQ-FeedbackEnabled is set to enabled for the highest priority LCH satisfying the above conditions; or 2) the parameter sl-HARQ-FeedbackEnabled is set to disabled, if sl-HARQ-FeedbackEnabled is set to disabled for the highest priority LCH satisfying the above conditions; else, the parameter sl-HARQ-FeedbackEnabled is set to disabled.

Note that the HARQ feedback enabled/disabled indicator is set to disabled for the transmission of a MAC PDU only carrying Channel State Information (CSI) reporting MAC-CE or SL DRX Command MAC-CE or SL Inter-UE Coordination Request MAC-CE or SL Inter-UE Coordination Information MAC-CE.

Described below are solutions to allow for efficient recovery for SL carrier failure, e.g., for SL carrier aggregation (CA). In various embodiments, carrier aggregation is used to increase the bandwidth, and thereby increase the bitrate, at a UE by allocating resources on multiple aggregated carriers. Each aggregated carrier is referred to as a component carrier (CC).

While presented as distinct solutions, one or more of the solutions described herein may be implemented in combination with each other for efficient CAPC handling for a SL transmission.

According to embodiments of the first solution, a new timer is introduced which controls the time when a previously removed (or released) SL carrier can be considered again by the UE for Carrier selection (e.g., for SL transmission). According to one implementation of the first solution, the new timer is used for the recovery of a released (or removed) carrier from the set of candidate carriers for carrier selection (or re-selection), e.g., for SL transmission. In one example the carrier was removed (or released) due to SL carrier failure having been detected for that carrier.

According to one implementation of the first solution, the timer controls the recovery of a SL carrier failure. In one example the SL carrier failure was detected (i.e., declared) for a carrier based on the number of consecutive DTX having reached (or exceeded) a preconfigured threshold, e.g., sl-MaxnumConsecutiveDTX, for the carrier.

In one implementation of the first solution, the new timer controlling the recovery of a SL carrier failure for a SL carrier which was previously released (or removed), is maintained per SL carrier. In one example the timer is referred to as sl-CarrierFailure-RecoveryTimer.

According to one implementation of the first solution, the timer is started upon declaration of a SL carrier failure for a carrier, e.g., when SL carrier failure has been triggered due to the number of consecutive DTX reaching (or exceeding) a preconfigured threshold.

According to one implementation of the first solution, a SL carrier for which the corresponding recovery timer, e.g., sl-CarrierFailure-RecoveryTimer, is running is not considered as a candidate carrier for Tx carrier (re-) selection. In one example the SL carrier is not considered as a candidate carrier for Tx carrier (re-) selection for any SL LCH.

Upon expiry of the timer, Tx UE can use the carrier again for SL transmissions, e.g., consider the SL carrier as a candidate carrier for Tx carrier (re-) selection. In one example UE cancels the triggered SL carrier failure upon expiry of the recovery timer. In one example UE adds (or configures) a previously removed (or released) SL carrier to the set of configured SL carrier(s) upon the cancellation of the SL carrier failure.

In one exemplary implementation of the first solution, the Tx UE 402 informs the Rx UE 404 about the added (or configured) SL Tx carrier in response to the cancellation of a SL carrier failure, e.g., PC5-RRC message of MAC-CE.

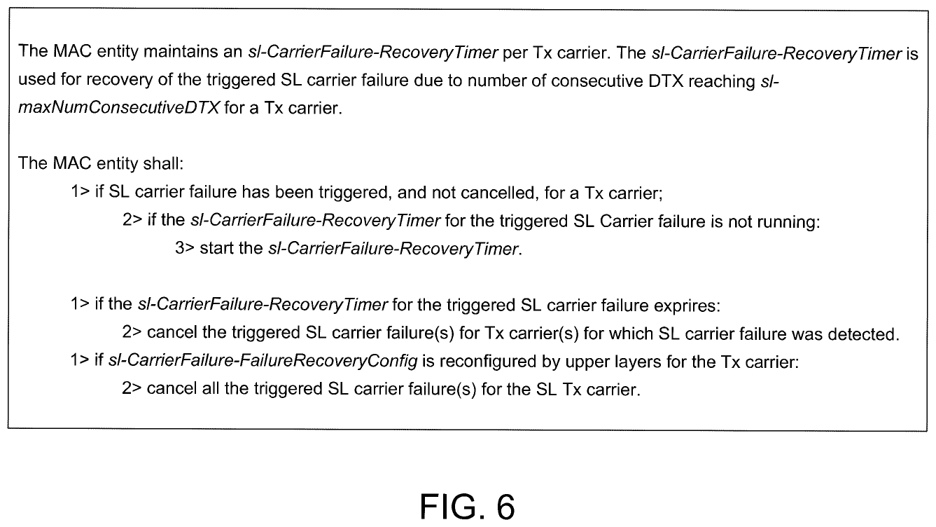

FIG. 6 illustrates an example of handling a SL carrier failure, in accordance with aspects of the present disclosure. The example of FIG. 6 depicts one implementation of the first solution, whereby a previously removed (or released) SL carrier can be considered again by the UE for Carrier selection (e.g., for SL transmission).

According to one implementation of the first solution, the timer controlling the recovery of a released (or removed) SL Tx carrier, e.g., sl-CarrierFailure-RecoveryTimer, is stopped or alternatively considered as expired for cases when UE sends a message to the gNB, e.g., on the UL Uu interface, informing the gNB about the corresponding SL carrier failure detected for the SL Tx carrier. In one example the UE cancels the triggered SL carrier failure and considers the SL carrier for Tx carrier selection (or re-selection) and SL transmissions upon transmission of a MAC-CE or RRC message informing the gNB about the detected SL carrier failure.

In one exemplary implementation of the first solution, the UE starts the sl-CarrierFailure-RecoveryTimer associated with a Tx carrier some predefined time offset after having declared a SL carrier failure for the SL Tx carrier. The predefined offset may be Oms, e.g., no time offset.

According to embodiments of a second solution, the UE triggers a SL carrier failure for cases that the number of RLC transmissions (and/or re-transmissions) reaches a predefined maximum (i.e., threshold). According to one implementation of the second solution, UE detects (i.e., triggers) a SL carrier failure if the number of RLC transmissions (and/or re-transmissions) performed on a SL carrier, e.g., LCH is mapped to the SL carrier, reaches (or exceeds) the predefined maximum value (i.e., threshold).

In response to detecting that the number of RLC transmissions (and/or re-transmissions) reaching a maximum value (i.e., threshold), the Tx UE suspends SL transmissions on that Tx carrier. In one example Tx UE removes (or releases) the Tx carrier. According to one specific implementation of the second solution, UE informs the gNB and/or the Rx UE about the SL carrier failure due to reaching the maximum number of RLC transmissions (and/or re-transmissions).

According to embodiments of a third solution, the UE disables PDCP duplication for a sidelink radio bearer (SLRB) for cases where the secondary leg(s)/carrier(s) being associated with the PDCP entity of the SLRB have been removed (or released) due to a detected SL carrier failure. According to one implementation of the third solution, the Tx UE disables PDCP duplication for the case where there is no secondary SL carrier available for a SLRB due to SL carrier failure(s) having occurred on the secondary carrier(s).

For example, if there are two SL carriers (carrier1 and carrier2) configured (or used), if DTX on carrier2 leads to the per-carrier failure on carrier2, e.g., number of consecutive DTX is exceeding a preconfigured threshold, carrier1 only cannot support PDCP duplication. Therefore, Tx UE disables PDCP duplication-even if PDCP duplication is configured for the SLRB. In one example MAC layer notifies PDCP layer to disable PDCP duplication. In another example MAC informs RRC layer about the SL carrier failure and RRC layer accordingly notifies PDCP layer to disable PDCP duplication.

According to embodiments of a fourth solution, the UE releases an LCH/bearer if the associated SL carrier(s) are removed (or released) due to SL carrier failure. According to one implementation of the fourth solution, a Tx UE releases a SL LCH/SLRB for cases where there is no associated SL carrier, e.g., there is no SL carrier available on which the SL LCH/SLRB is allowed to be mapped. For cases when SL carrier failure has been detected on (all of) the associated SL carrier(s), e.g., LCH-to-carrier as indicated by upper layer, the Tx UE releases the corresponding SL LCH/SLRB.

In one implementation of the fourth solution, a UE triggers SL RLF if all SL carriers associated with a SL LCH/SLRB are removed (or released) due to a SL carrier failure having been detected for each of the associated SL carriers. In one example UE triggers a SL RLF for the corresponding PC5-RRC connection, e.g., PC5-RRC connection associated with the SL LCH/SLRB.

According to embodiments of a fifth solution, the UE suspends a bearer/LCH if the associated SL carrier(s) are removed (or released) due to SL carrier failure(s) detected for those associated SL carrier(s). According to one implementation of the fifth solution, the Tx UE suspends an SL LCH/SLRB in case there is no associated SL carrier available due to SL carrier failure, e.g., number of number consecutive DTX have exceeded a preconfigured threshold for the corresponding SL carrier(s).

In one example UE is not requesting SL resources for data pending for a suspended SL LCH/SLRB. In one example MAC is not reporting data pending for transmission for a suspended SL LCH/SLRB in a SL buffer status report (BSR). Accordingly, the arrival of data for a suspended SL LCH/SLRB does not trigger a BSR (or scheduling request (SR)).

According to embodiments of a sixth solution, the UE performs an LCH-to-carrier remapping for cases when SL failure was detected for the carrier(s) configured as allowed by the upper layer. According to one implementation of the sixth solution, the UE (e.g., Tx UE) maps a LCH for which the configured associated SL carrier (by upper layer) is no longer available for SL transmissions due to SL carrier failure having been detected for those SL carrier(s) on a different available SL carrier.

In one example, a UE (e.g., RRC layer) autonomously changes the LCH-to-carrier mapping in order to ensure that data of this LCH can be still transmitted. In one example, UE maps the LCH to the SL carrier which was initially used by the UE before configuring CA aggregation. According to one example, there is one SL carrier which allowed for each SL LCH for cases when SL carrier failure has been detected for the configured associated SL carrier(s) (LCH-to-Carrier mapping according to upper layer). In one example this SL carrier is referred to as primary SL carrier.

According to one implementation of the sixth solution, an LCH/SLRB for which there are no associated (or allowed) SL carrier available due to SL carrier failure is allowed to be mapped to any available SL carrier, e.g., no LCH-to-carrier mapping restriction.

According to embodiments of a seventh solution, the threshold for declaring SL carrier failure is configured per SL carrier. In one implementation of the seventh solution, different thresholds for detecting SL carrier failure could be configured for different SL carriers. In one example sl-MaxnumConsecutiveDTX may be configured with different values for different SL carriers.

According to embodiments of an eighth solution, the UE informs the gNB about a SL carrier failure, e.g., in case the number of consecutive DTX reaching a predefined threshold for the SL carrier. According to one implementation of the eighth solution, the SL carrier failure is reported in an RRC message.

In one example a new MAC-CE is introduced to signal the SL carrier failure. For mode 1 resource allocation, the gNB considers the status of SL Tx carrier(s) for the future SL scheduling. In another example the SL carrier failure MAC-CE sent on Uu (e.g., uplink transmission) to the gNB is identified by a MAC subheader with a specific Logical Channel Identifier (LCID), for example, a reserved LCID. In a further example, a SR configuration is associated with the new Uu MAC-CE, e.g., UE triggers an SR for cases that the MAC-CE was triggered but UE has no available UL grant (or PUSCH resources).

In one example the SL carrier message sent by the UE to the gNB, e.g., new MAC-CE or RRC message, contains and identification of the SL Tx carrier(s) for which a SL carrier failure was detected. In one example the Message is comprised of a bitmap where each bit of the bitmap corresponds to a configured SL Tx carrier. In one exemplary implementation the bit set to ‘1’ indicates that a SL carrier failure has been detected for the corresponding SL Tx carrier, whereas the bit set ‘0’ indicates that no SL carrier failure has been detected.

According to one implementation of the eighth solution, the UE triggers the transmission of a message informing the gNB about a cancelled SL carrier failure in response to UE cancelling the previously triggered SL carrier failure, e.g., at the expiry of the sl-CarrierFailure-RecoveryTimer.

According to another implementation of the eighth solution, gNB starts a timer upon reception of a message indicating detected SL carrier failure(s). While the timer is running the gNB considers the SL Tx carrier(s) for which a carrier failure was indicated within the message as unavailable for SL transmission. Upon expiry of the timer gNB considers the SL Tx carrier(s) as candidates for SL Tx carrier selection (e.g., for SL transmission). In one example the timer started at the gNB is set to the same value as the sl-CarrierFailure-RecoveryTimer.

In one example, the SL carrier failure message, e.g., MAC-CE or RRC message, which is sent to the gNB and/or peer Rx UE is comprised of a field indicating the failure type. In one example, the failure type is set to ‘DTX-based RLF’ for cases that a SL carrier failure was detected due to the number of consecutive DTX reaching (or exceeding) a predefined threshold. In another example, the failure type is set to ‘RLC-MaxNumReTx’ for cases that the number of RLC transmissions (and/or re-transmissions) reach (or exceed) a predefined threshold (e.g., a maximum value).

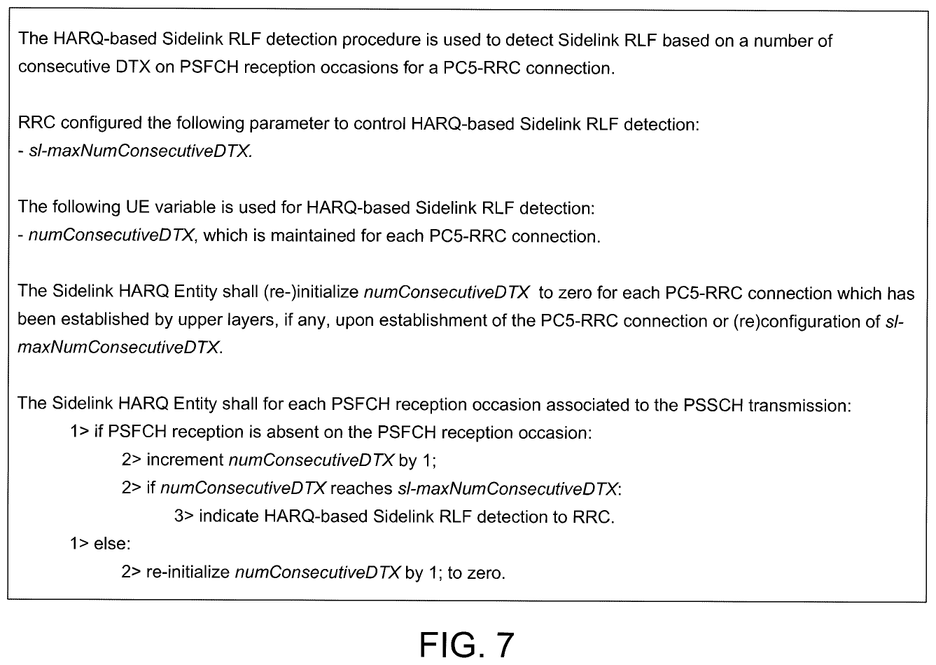

FIG. 7 illustrates an example of detecting SL RLF, in accordance with aspects of the present disclosure. The example of FIG. 7 depicts one implementation for HARQ-based SL RLF detection, in accordance with the second solution. The HARQ-based SL RLF detection may be based on a number of consecutive DTX instances detected. According to the above embodiments it is assumed that SL RLF detection is performed per SL carrier. Thus, RLF may be triggered, e.g., for the PC5-RRC connection, only when a carrier RLF condition is detected for all configured SL carriers.

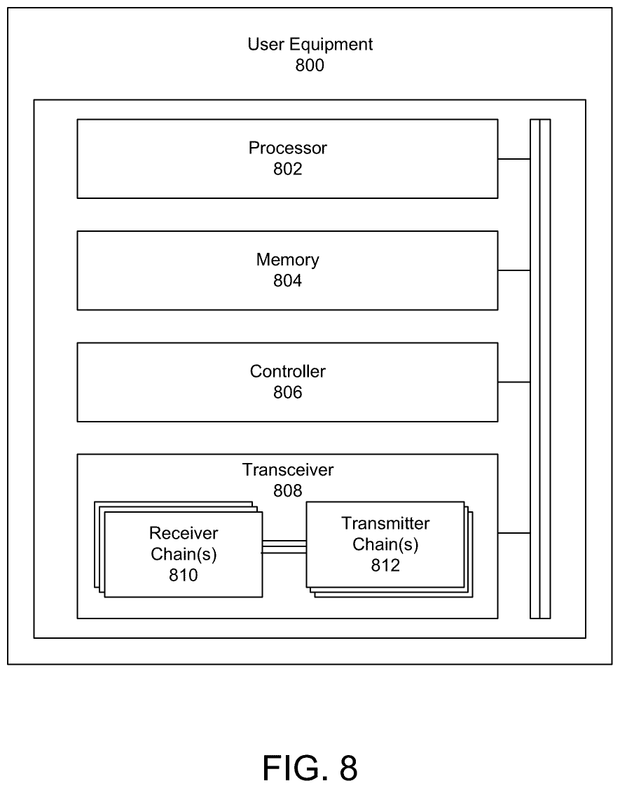

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a central processing unit (CPU), an ASIC, a field programmable gate array (FPGA), or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions that, when executed by the processor 802, cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the UE functions described herein (e.g., executing, by the processor 802, instructions stored in the memory 804). Accordingly, the processor 802 may support wireless communication at the UE 800 in accordance with examples as disclosed herein. For example, the UE 800 may be configured to support a means for receiving a configuration for a set of SL carriers, where the set of SL carriers corresponds to a set of candidate carriers for SL transmissions.

The UE 800 may be configured to support a means for determining whether a SL carrier failure condition occurs for at least one SL carrier of the set of SL carriers. In some embodiments, the UE 800 is configured to detect the SL carrier failure condition based on a number of consecutive DTX instances reaching a predefined threshold.

The UE 800 may be configured to support a means for initiating a carrier-specific timer associated with a respective SL carrier based at least in part on a determination that the SL carrier failure condition has occurred for the respective SL carrier and to support a means for clearing the SL carrier failure condition for the respective SL carrier in response to an expiry of the timer.

In some embodiments, the UE 800 is configured to remove the respective SL carrier from the set of configured SL carriers in response to determination that the SL carrier failure condition has occurred. In such embodiments, the UE 800 may be configured to add the respective SL carrier to the set of configured SL carriers upon the expiry of the carrier-specific timer.

In some embodiments, the UE 800 is configured to disregard the respective SL carrier as a candidate carrier for SL transmissions in response to determination that the SL carrier failure condition has occurred. In such embodiments, the UE 800 may be configured to consider the respective SL carrier as a candidate carrier for SL transmissions upon the expiry of the carrier-specific timer.

In various implementations, the UE 800 may be configured to support a means for receiving a configuration that indicates a plurality of carriers for SL communication. The UE 800 may be configured to support a means for tracking a number of consecutive DTX instances for each SL carrier of the plurality of carriers.

The UE 800 may be configured to support a means for determining a carrier failure condition for a respective SL carrier based at least in part on a tracked number of consecutive DTX instances satisfying a threshold. In some embodiments, the UE 800 is configured to receive an RRC message comprising the threshold. In certain embodiments, the configuration indicating a plurality of carriers for SL communication is an RRC configuration message that also includes the threshold number of consecutive DTX instances for determining the carrier failure condition.

In some embodiments, the UE 800 is configured to determine the carrier failure condition for the respective SL carrier based at least in part on a number of RLC retransmission satisfying a second threshold. In certain embodiments, the notification further comprises an indication of a failure type associated with the carrier failure condition.

The UE 800 may be configured to support a means for transmitting a notification to a base station, the notification indicating the carrier failure condition for the respective SL carrier. In some embodiments, the notification comprises a bitmap that indicates each SL carrier of the plurality of carriers for which the carrier failure condition applies.

In some embodiments, the UE 800 is configured to receive an updated SL resource allocation from the base station, based at least in part on the notification indicating the carrier failure condition for the respective SL carrier.

In some embodiments, to transmit the notification to the base station, the UE 800 is configured to transmit an RRC message comprising SL UE information, where the SL UE information indicates each SL carrier of the plurality of carriers for which the carrier failure condition applies.

In some embodiments, to transmit the notification to the base station, the UE 800 is configured to transmit MAC-CE indicating each SL carrier of the plurality of carriers for which the carrier failure condition applies. In such embodiments, the MAC-CE is associated with a reserved LCID indicating the carrier failure condition.

In some embodiments, to transmit the notification to the base station, the UE 800 is configured to transmit a MAC-CE indicating each SL carrier of the plurality of carriers for which the carrier failure condition applies. In such embodiments, the MAC-CE is associated with a SR configuration for indicating the carrier failure condition.

In some embodiments, to track the number of consecutive DTX instances, the UE 800 is configured to: A) initialize, for each SL carrier of the plurality of carriers, a variable to zero; B) perform HARQ based SL communication with at least one SL Rx UE; C) increment a respective variable in response to determining a DTX instance for a corresponding SL carrier based at least in part on the HARQ based SL communication; and D) reset the respective variable in response to determining a non-DTX instance for a corresponding SL carrier based at least in part on the HARQ based SL communication.

In some embodiments, the UE 800 is configured to: A) release the respective SL carrier in response to a determination of the carrier failure condition for the respective SL carrier; and B) transmit a second notification to at least one SL Rx UE, the second notification indicating the carrier failure condition for the respective SL carrier.

In some embodiments, the UE 800 is configured to: A) release the respective SL carrier in response to a determination of the carrier failure condition for the respective SL carrier; B) trigger a SL RLF in response to all SL carriers associated with a SLRB being released due to SL carrier failure; and C) transmit a second notification to the base station, the second notification indicating a SL RLF condition associated with the SLRB.

In some embodiments, the UE 800 is configured to: A) release the respective SL carrier in response to a determination of the carrier failure condition for the respective SL carrier; and B) disable a PDCP duplication for a SLRB in response to all SL carriers associated with the SLRB being released due to SL carrier failure.

The controller 806 may manage input and output signals for the UE 800. The controller 806 may also manage peripherals not integrated into the UE 800. In some implementations, the controller 806 may utilize an operating system (OS) such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

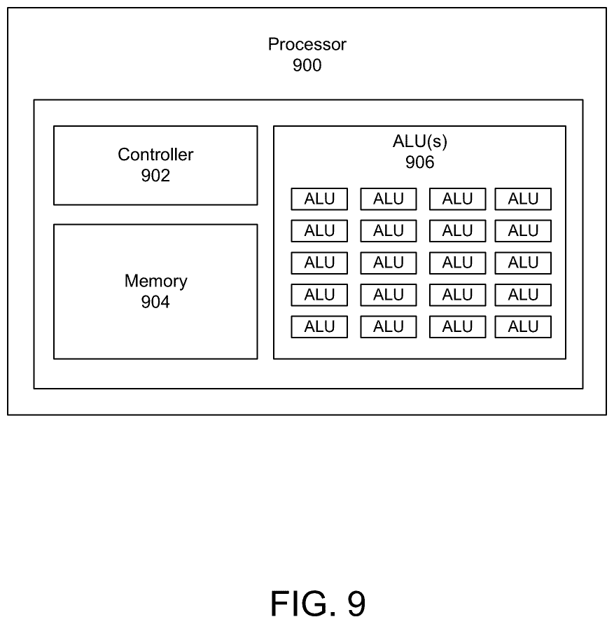

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1, or L2, or L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

In various embodiments, the processor 900 may support the functions of a UE, in accordance with examples as disclosed herein. For example, the processor 900 may be configured to support a means for receiving a configuration for a set of SL carriers, where the set of SL carriers corresponds to a set of candidate carriers for SL transmissions.

The processor 900 may be configured to support a means for determining whether a SL carrier failure condition occurs for at least one SL carrier of the set of SL carrier. In some embodiments, the processor 900 is configured to detect the SL carrier failure condition based on a number of consecutive DTX instances reaching a predefined threshold.

The processor 900 may be configured to support a means for initiating a carrier-specific timer associated with a respective SL carrier based at least in part on a determination that the SL carrier failure condition has occurred for the respective SL carrier and to support a means for clearing the SL carrier failure condition for the respective SL carrier in response to an expiry of the timer.

In some embodiments, the processor 900 is configured to remove the respective SL carrier from the set of configured SL carriers in response to determination that the SL carrier failure condition has occurred. In such embodiments, the processor 900 may be configured to add the respective SL carrier to the set of configured SL carriers upon the expiry of the carrier-specific timer.

In some embodiments, the processor 900 is configured to disregard the respective SL carrier as a candidate carrier for SL transmissions in response to determination that the SL carrier failure condition has occurred. In such embodiments, the processor 900 may be configured to consider the respective SL carrier as a candidate carrier for SL transmissions upon the expiry of the carrier-specific timer.

In various implementations, the processor 900 may be configured to support a means for receiving a configuration that indicates a plurality of carriers for SL communication. The processor 900 may be configured to support a means for tracking a number of consecutive DTX instances for each SL carrier of the plurality of carriers.

The processor 900 may be configured to support a means for determining a carrier failure condition for a respective SL carrier based at least in part on a tracked number of consecutive DTX instances satisfying a threshold. In some embodiments, the processor 900 is configured to receive an RRC message comprising the threshold. In certain embodiments, the configuration indicating a plurality of carriers for SL communication is an RRC configuration message that also includes the threshold number of consecutive DTX instances for determining the carrier failure condition.

In some embodiments, the processor 900 is configured to determine the carrier failure condition for the respective SL carrier based at least in part on a number of RLC retransmission satisfying a second threshold. In certain embodiments, the notification further comprises an indication of a failure type associated with the carrier failure condition.

The processor 900 may be configured to support a means for transmitting a notification to a base station, the notification indicating the carrier failure condition for the respective SL carrier. In some embodiments, the notification comprises a bitmap that indicates each SL carrier of the plurality of carriers for which the carrier failure condition applies.

In some embodiments, the processor 900 is configured to receive an updated SL resource allocation from the base station, based at least in part on the notification indicating the carrier failure condition for the respective SL carrier.

In some embodiments, to transmit the notification to the base station, the processor 900 is configured to transmit an RRC message comprising SL UE information, where the SL UE information indicates each SL carrier of the plurality of carriers for which the carrier failure condition applies.

In some embodiments, to transmit the notification to the base station, the processor 900 is configured to transmit MAC-CE indicating each SL carrier of the plurality of carriers for which the carrier failure condition applies. In such embodiments, the MAC-CE is associated with a reserved LCID indicating the carrier failure condition.

In some embodiments, to transmit the notification to the base station, the processor 900 is configured to transmit a MAC-CE indicating each SL carrier of the plurality of carriers for which the carrier failure condition applies. In such embodiments, the MAC-CE is associated with a SR configuration for indicating the carrier failure condition.

In some embodiments, to track the number of consecutive DTX instances, the processor 900 is configured to: A) initialize, for each SL carrier of the plurality of carriers, a variable to zero; B) perform HARQ based SL communication with at least one SL Rx UE; C) increment a respective variable in response to determining a DTX instance for a corresponding SL carrier based at least in part on the HARQ based SL communication; and D) reset the respective variable in response to determining a non-DTX instance for a corresponding SL carrier based at least in part on the HARQ based SL communication.

In some embodiments, the processor 900 is configured to: A) release the respective SL carrier in response to a determination of the carrier failure condition for the respective SL carrier; and B) transmit a second notification to at least one SL Rx UE, the second notification indicating the carrier failure condition for the respective SL carrier.

In some embodiments, the processor 900 is configured to: A) release the respective SL carrier in response to a determination of the carrier failure condition for the respective SL carrier; B) trigger a SL RLF in response to all SL carriers associated with a SLRB being released due to SL carrier failure; and C) transmit a second notification to the base station, the second notification indicating a SL RLF condition associated with the SLRB.

In some embodiments, the processor 900 is configured to: A) release the respective SL carrier in response to a determination of the carrier failure condition for the respective SL carrier; and B) disable a PDCP duplication for a SLRB in response to all SL carriers associated with the SLRB being released due to SL carrier failure.

In various embodiments, the processor 900 may support the functions of a base station, in accordance with examples as disclosed herein. For example, the processor 900 may be configured to support a means for transmitting a configuration that indicates a plurality of carriers for SL communication and a threshold for carrier failure.

The processor 900 may be configured to support a means for receiving a notification from a UE, the notification indicating a carrier failure condition for a respective SL carrier of the plurality of carriers based on a tracked number of consecutive DTX instances satisfying the threshold.

The processor 900 may be configured to support a means for scheduling an SL resource allocation based at least in part on the notification indicating the carrier failure condition for the respective SL carrier. The processor 900 may be configured to support a means for transmitting the SL resource allocation from the UE.

In some embodiments, to receive the notification, the processor 900 is configured to receive a RRC message comprising SL UE information indicating each SL carrier of the plurality of carriers for which the carrier failure condition applies.

In some embodiments, the notification further comprises an indication of a failure type associated with the carrier failure condition. In such embodiments, the processor 900 may be configured to determine the carrier failure condition for the respective SL carrier based at least in part on the failure type, wherein the failure type indicates failure based on the number of consecutive DTX instances satisfying the threshold or based at least in part on a number of RLC retransmission satisfying a second threshold.

In some embodiments, the notification further comprises an indication that the respective SL carrier is released due to the carrier failure condition for the respective SL carrier. In such embodiments, the notification may indicate a failure type associated with the carrier failure condition.

In some embodiments, the processor 900 is configured to receive a second notification from the UE, the second notification indicating a SL RLF condition associated with a SLRB in response to all SL carriers associated with the SLRB being released due to SL carrier failure.

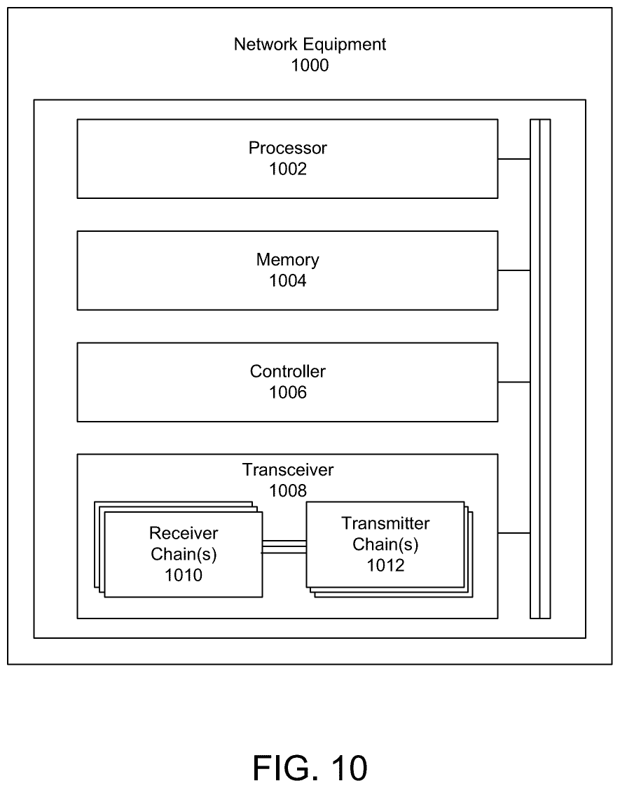

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the RAN functions described herein (e.g., executing, by the processor 1002, instructions stored in the memory 1004). For example, the processor 1002 may support wireless communication at the NE 1000 in accordance with examples as disclosed herein.

In various embodiments, the NE 1000 may be configured to support a means for transmitting a configuration that indicates a plurality of carriers for SL communication and a threshold for carrier failure.

The NE 1000 may be configured to support a means for receiving a notification from a UE, the notification indicating a carrier failure condition for a respective SL carrier of the plurality of carriers based on a tracked number of consecutive DTX instances satisfying the threshold.

The NE 1000 may be configured to support a means for scheduling an SL resource allocation based at least in part on the notification indicating the carrier failure condition for the respective SL carrier. The NE 1000 may be configured to support a means for transmitting the SL resource allocation from the UE.

In some embodiments, to receive the notification, the NE 1000 is configured to receive a RRC message comprising SL UE information indicating each SL carrier of the plurality of carriers for which the carrier failure condition applies.

In some embodiments, the notification further comprises an indication of a failure type associated with the carrier failure condition. In such embodiments, the NE 1000 may be configured to determine the carrier failure condition for the respective SL carrier based at least in part on the failure type, wherein the failure type indicates failure based on the number of consecutive DTX instances satisfying the threshold or based at least in part on a number of RLC retransmission satisfying a second threshold.

In some embodiments, the notification further comprises an indication that the respective SL carrier is released due to the carrier failure condition for the respective SL carrier. In such embodiments, the notification may indicate a failure type associated with the carrier failure condition.

In some embodiments, the NE 1000 is configured to receive a second notification from the UE, the second notification indicating a SL RLF condition associated with a SLRB in response to all SL carriers associated with the SLRB being released due to SL carrier failure.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receiving the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the received signal and obtain the transmitted data by reversing the modulation technique applied during transmission of the signal. The receiver chain 1010 may include at least one decoder for decoding/processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

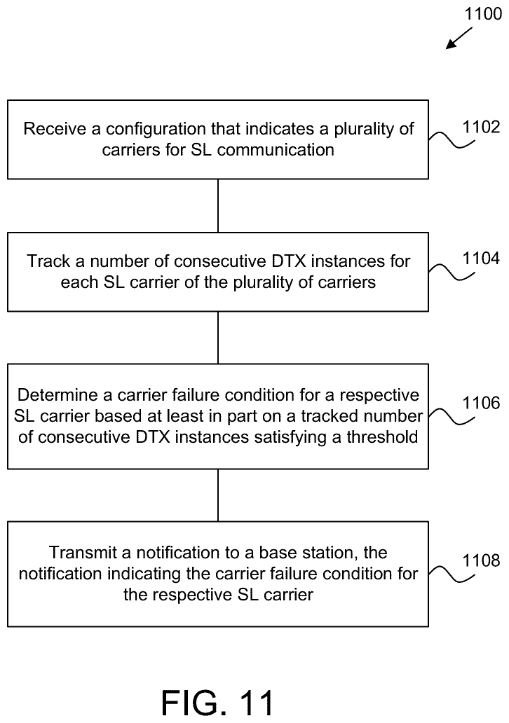

FIG. 11 depicts one embodiment of a method 1100 in accordance with aspects of the present disclosure. The operations of the method 1100 may be implemented by a UE as described herein. In some implementations, the UE may execute a set of instructions to control the function elements of the UE to perform the described functions.

At step 1102, the method 1100 may include receiving a configuration that indicates a plurality of carriers for SL communication. The operations of step 1102 may be performed in accordance with examples as described herein. In some implementations, aspects of the operations of step 1102 may be performed by a UE, as described with reference to FIG. 8.

At step 1104, the method 1100 may include tracking a number of consecutive DTX instances for each SL carrier of the plurality of carriers. The operations of step 1104 may be performed in accordance with examples as described herein. In some implementations, aspects of the operations of step 1104 may be performed by a UE, as described with reference to FIG. 8.

At step 1106, the method 1100 may include determining a carrier failure condition for a respective SL carrier based at least in part on a tracked number of consecutive DTX instances satisfying a threshold. The operations of step 1106 may be performed in accordance with examples as described herein. In some implementations, aspects of the operations of step 1106 may be performed by a UE, as described with reference to FIG. 8.

At step 1108, the method 1100 may include transmitting a notification to a base station, the notification indicating the carrier failure condition for the respective SL carrier. The operations of step 1108 may be performed in accordance with examples as described herein. In some implementations, aspects of the operations of step 1108 may be performed by a UE, as described with reference to FIG. 8.

It should be noted that the method 1100 described herein describes one possible implementation, and that the operations and the steps may be rearranged or otherwise modified and that other implementations are possible.

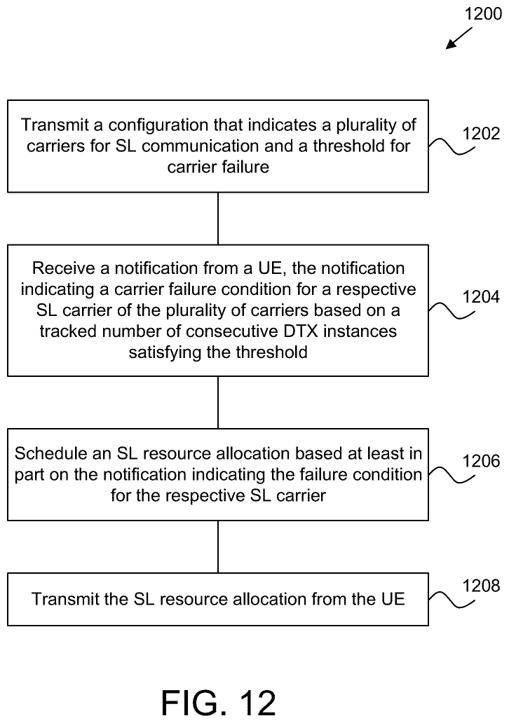

FIG. 12 depicts one embodiment of a method 1200 in accordance with aspects of the present disclosure. The operations of the method 1200 may be implemented by a NE as described herein. In some implementations, the NE may execute a set of instructions to control the function elements of the NE to perform the described functions.

At step 1202, the method 1200 may include transmitting a configuration that indicates a plurality of carriers for SL communication and a threshold for carrier failure. The operations of step 1202 may be performed in accordance with examples as described herein. In some implementations, aspects of the operations of step 1202 may be performed by a NE, as described with reference to FIG. 10.

At step 1204, the method 1200 may include receiving a notification from a UE, the notification indicating a carrier failure condition for a respective SL carrier of the plurality of carriers based on a tracked number of consecutive DTX instances satisfying the threshold. The operations of step 1204 may be performed in accordance with examples as described herein. In some implementations, aspects of the operations of step 1204 may be performed by a NE, as described with reference to FIG. 10.

At step 1206, the method 1200 may include scheduling an SL resource allocation based at least in part on the notification indicating the carrier failure condition for the respective SL carrier. The operations of step 1206 may be performed in accordance with examples as described herein. In some implementations, aspects of the operations of step 1206 may be performed by a NE, as described with reference to FIG. 10.

At step 1208, the method 1200 may include transmitting the SL resource allocation from the UE. The operations of step 1208 may be performed in accordance with examples as described herein. In some implementations, aspects of the operations of step 1208 may be performed by a NE, as described with reference to FIG. 10.

It should be noted that the method 1200 described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration that indicates a plurality of carriers for sidelink (SL) communication;
track a number of consecutive discontinuous transmission (DTX) instances for each SL carrier of the plurality of carriers;
determine a carrier failure condition for a respective SL carrier based at least in part on a tracked number of consecutive DTX instances satisfying a threshold; and
transmit a notification to a base station, the notification indicating the carrier failure condition for the respective SL carrier.

2. The UE of claim 1, wherein the at least one processor is configured to cause the UE to receive an updated SL resource allocation from the base station, based at least in part on the notification indicating the carrier failure condition for the respective SL carrier.

3. The UE of claim 1, wherein to transmit the notification to the base station, the at least one processor is configured to cause the UE to transmit a radio resource control (RRC) message comprising SL UE information indicating each SL carrier of the plurality of carriers for which the carrier failure condition applies.

4. The UE of claim 1, wherein the notification comprises a bitmap that indicates each SL carrier of the plurality of carriers for which the carrier failure condition applies.

5. The UE of claim 1, wherein to transmit the notification to the base station, the at least one processor is configured to cause the UE to transmit medium access control (MAC) control element (MAC-CE) indicating each SL carrier of the plurality of carriers for which the carrier failure condition applies, wherein the MAC-CE is associated with a reserved logical channel identifier (LCID) indicating the carrier failure condition.

6. The UE of claim 1, wherein to transmit the notification to the base station, the at least one processor is configured to cause the UE to transmit a medium access control (MAC) control element (MAC-CE) indicating each SL carrier of the plurality of carriers for which the carrier failure condition applies, wherein the MAC-CE is associated with a scheduling request (SR) configuration for indicating the carrier failure condition.

7. The UE of claim 1, wherein the at least one processor is configured to cause the UE to receive a radio resource control (RRC) message comprising the threshold.

8. The UE of claim 1, wherein to track the number of consecutive DTX instances, the at least one processor is configured to cause the UE to:
initialize, for each SL carrier of the plurality of carriers, a variable to zero;
perform hybrid automatic repeat request (HARQ) based SL communication with at least one SL receiver UE (Rx UE);
increment a respective variable in response to determining a DTX instance for a corresponding SL carrier based at least in part on the HARQ based SL communication; and
reset the respective variable in response to determining a non-DTX instance for a corresponding SL carrier based at least in part on the HARQ based SL communication.

9. The UE of claim 1, wherein the at least one processor is configured to cause the UE to determine the carrier failure condition for the respective SL carrier based at least in part on a number of radio link control (RLC) retransmission satisfying a second threshold.

10. The UE of claim 9, wherein the notification further comprises an indication of a failure type associated with the carrier failure condition.

11. The UE of claim 1, wherein the at least one processor is configured to cause the UE to:
release the respective SL carrier in response to a determination of the carrier failure condition for the respective SL carrier; and
transmit a second notification to at least one SL receiver UE (Rx UE), the second notification indicating the carrier failure condition for the respective SL carrier.

12. The UE of claim 1, wherein the at least one processor is configured to cause the UE to:
release the respective SL carrier in response to a determination of the carrier failure condition for the respective SL carrier;
trigger a SL radio link failure (RLF) in response to all SL carriers associated with a SL radio bearer (SLRB) being released due to SL carrier failure; and
transmit a second notification to the base station, the second notification indicating a SL RLF condition associated with the SLRB.

13. The UE of claim 1, wherein the at least one processor is configured to cause the UE to:
release the respective SL carrier in response to a determination of the carrier failure condition for the respective SL carrier; and
disable a packet data convergence protocol (PDCP) duplication for a SL radio bearer (SLRB) in response to all SL carriers associated with the SLRB being released due to SL carrier failure.

14. A processor for wireless communication, comprising:
at least one controller coupled with at least one memory and configured to cause the processor to:
receive a configuration that indicates a plurality of carriers for sidelink (SL) communication;
track a number of consecutive discontinuous transmission (DTX) instances for each SL carrier of the plurality of carriers;
determine a carrier failure condition for a respective SL carrier based at least in part on a tracked number of consecutive DTX instances satisfying a threshold; and
transmit a notification to a base station, the notification indicating the carrier failure condition for the respective SL carrier.

15. A base station for wireless communication, comprising:
at least one memory; and
at least one processor coupled with the at least one memory and configured to cause the base station to:
transmit a configuration that indicates a plurality of carriers for sidelink (SL) communication and a threshold for carrier failure;
receive a notification from a user equipment (UE), the notification indicating a carrier failure condition for a respective SL carrier of the plurality of carriers based on a tracked number of consecutive discontinuous transmission (DTX) instances satisfying the threshold;
schedule an SL resource allocation based at least in part on the notification indicating the carrier failure condition for the respective SL carrier; and
transmit the SL resource allocation from the UE.

16. The base station of claim 15, wherein to receive the notification, the at least one processor is configured to cause the base station to receive a radio resource control (RRC) message comprising SL UE information indicating each SL carrier of the plurality of carriers for which the carrier failure condition applies.

17. The base station of claim 15, wherein the at least one processor is configured to cause the base station to determine the carrier failure condition for the respective SL carrier based at least in part on a number of radio link control (RLC) retransmission satisfying a second threshold.

18. The base station of claim 15, wherein the notification further comprises an indication that the respective SL carrier is released due to the carrier failure condition for the respective SL carrier, wherein the notification further comprises an indication of a failure type associated with the carrier failure condition.

19. The base station of claim 15, wherein the at least one processor is configured to cause the base station to receive a second notification from the UE, the second notification indicating a SL radio link failure (RLF) condition associated with a SL radio bearer (SLRB) in response to all SL carriers associated with the SLRB being released due to SL carrier failure.

20. A method performed by a base station, the method comprising:
transmitting a configuration that indicates a plurality of carriers for sidelink (SL) communication and a threshold for carrier failure;
receiving a notification from a user equipment (UE), the notification indicating a carrier failure condition for a respective SL carrier of the plurality of carriers based on a tracked number of consecutive discontinuous transmission (DTX) instances satisfying the threshold;
scheduling an SL resource allocation based at least in part on the notification indicating the carrier failure condition for the respective SL carrier; and
transmitting the SL resource allocation from the UE.
